(19) United States
(12) Patent Application Publication
(10) Pub. No.: US 2025/0256309 A1
(43) Pub. Date: Aug. 14, 2025

(54) SANDSPLASH SYSTEM FOR REMOVING CONTAMINANTS FROM POLYMER COMPONENTS

(71) Applicant: Flyshots Apps (OPC) Private Limited, Faridabad (IN)

(72) Inventor: Priya Manglik, Hapur (IN)

(21) Appl. No.: 18/963,823

(22) Filed: Nov. 29, 2024

(30) Foreign Application Priority Data
Feb. 13, 2024 (IN) 202411009791

(51) Int. Cl. B09B 3/30; B09B 3/40; B09B 101/75; B24C 1/08; C08J 11/06

(52) U.S. Cl. CPC B09B 3/30; B09B 3/40; B24C 1/08; C08J 11/06; B09B 2101/75

(57) ABSTRACT

The present disclosure pertains to a system (100) and a method (200) for removing contaminants from polymer components. The system (100) includes a chamber (102), a nozzle (104) configured to allow a mixture of air jet and a blasting media (106) in a predefined portion to be splashed on the polymer components within the chamber (102). The chamber (102) is configured to correspondingly allow a tumbling operation on the polymer components using the blasting media (106) within the chamber (102) to remove contaminants from the polymer components.

### CROSS-REFERENCE TO RELATED APPLICATION

The present application claims priority from Indian Patent Application No. 202411009791 filed on Feb. 13, 2024, the contents of which are incorporated herein by reference in their entirety.

### TECHNICAL FIELD

The present disclosure, in general, relates to the technical field of waste management and recycling systems. In particular, it pertains to a simple, compact, and efficient sandsplash system for removing contaminants from polymer components, plastic waste, and Municipal Solid Waste (MSW).

### BACKGROUND

Background description includes information that may be useful in understanding the present invention. It is not an admission that any of the information provided herein is prior art or relevant to the presently claimed invention, or that any publication specifically or implicitly referenced is prior art.

In the present scenario, the growing global population and rapid urbanization have led to a significant increase in the generation of Municipal Solid Waste (MSW). In India prospective, the annual production of MSW has surpassed 62 million metric tons, originating from various sources, including households, industries, and businesses. Unfortunately, a lack of awareness, combined with inadequate waste disposal systems, has resulted in the amalgamation of different waste types such as wet, dry, plastic, paper, metals, and glass, leading to the formation of towering waste heaps. Regrettably, existing water-based plastic waste cleaning systems exhibit limitations and inefficiencies, impeding the subsequent treatment, processing, cleaning, and recycling of plastic waste. This impediment hinders the seamless integration of plastic waste into the circular economy value addition chain.

In addition, the classification of Municipal Solid Waste includes both biodegradable and non-biodegradable waste, further categorized into recyclables and non-recyclables. The primary challenge may lie in the effective management of plastic waste, as current recycling methods face obstacles related to the inefficient removal of contaminants from plastic materials. The prevalent washing techniques employing water not only contribute to water contamination but also result in high energy consumption during the drying process. Moreover, these techniques prove ineffective in eliminating plastic waste from both floatable and non-floatable contaminants.

Further, as per the above mentioned, there may be an urgent need to provide an eco-friendly alternative that addresses the drawbacks associated with traditional approaches. Additionally, there may be a substantial imperative for sustainable plastic waste management, facilitating the dry cleaning of untreated plastic waste and rendering it recyclable for seamless integration into the circular economy chain.

There is, therefore, a requirement in the art to overcome the above-mentioned problems by providing a simple, compact, and efficient sandsplash system for removing contaminants from polymer components, plastic waste, and Municipal Solid Waste (MSW).

### SUMMARY

Aspects of the present disclosure in general pertain to waste management and recycling systems. In particular, it pertains to a simple, compact, and efficient sandsplash system for removing contaminants from polymer components, plastic waste, and Municipal Solid Waste (MSW). According to an aspect, the present disclosure elaborates upon a sandsplash system for removing contaminants from polymer components. The system includes a chamber, a nozzle, and a blasting media. The nozzle is configured to allow a mixture to be splashed on the polymer components within the chamber. The mixture includes a predefined portion of an air jet and a blasting media. The chamber is configured to correspondingly allow a tumbling operation on the polymer components. The tumbling operation is performed using the blasting media within the chamber to remove contaminants from the polymer components.

In an embodiment, the system may include an air compressor. The air compressor may be operatively coupled to the nozzle. The air compressor may be configured to generate the air jet.

In another embodiment, the system may include a separating unit. The separating unit may be operatively coupled to the chamber. The separating unit may be configured to separate a raw polymer components received from a municipal solid waste.

Yet in another embodiment, the system may include a shredding unit. The shredding unit may be operatively coupled to the chamber. The shredding unit may be configured to shred the polymer components received from the separating unit. The shredding unit may correspondingly transfer the shredded polymer components to the chamber.

Yet in another embodiment, the system may include a heating unit. The heating unit may be operatively coupled to the nozzle. The heating unit may be configured to receive an air jet from the air compressor. The heating unit may heat the received air jet. In addition, the heating unit may transfer the heated air jet to the chamber containing the shredded polymer components with moisture. Further, the heating unit may circulate the heated air jet within the chamber to remove moisture from the shredded polymer components.

Yet in another embodiment, the chamber may be configured to enable at least one of a vibration mode or a rotation mode. The vibration mode or the rotation mode may facilitate the tumbling operation on the polymer components upon removing moisture from the polymer components.

Yet in another embodiment, the polymer components may be any or combination of a PET (polyethylene terephthalate), a HDPE (high-density polyethylene), a PVC (polyvinyl chloride), a LDPE (low-density polyethylene), and a PP (polypropylene), and a PS (polystyrene).

Yet in another embodiment, the blasting media may be a sand.

According to another aspect, the present disclosure pertains to a method for removing contaminants from polymer components. The method comprises the step of separating using a separating unit, a raw polymer components received from municipal solid waste. The method comprises the step of shredding, using a shredding unit, the separated raw polymer components upon separating.

In addition, the method comprises the step of drying, using a heating unit, the shredded polymer components to remove moisture upon shedding. Further, the method comprises the step of splashing, using a nozzle a mixture of air-jet and a blasting media in a predefined portion to be splashed on the dried polymer components within a chamber upon drying.

Further, the method comprises the step of tumbling, using the chamber, the splashed polymer components with the blasting media to remove contaminants from the polymer components. Furthermore, the method comprises the step of collecting, using a container, the polymer components free from contaminants upon tumbling operation.

Various objects, features, aspects, and advantages of the inventive subject matter will become more apparent from the following detailed description of preferred embodiments, along with the accompanying drawing figures in which like numerals represent like components.

### OBJECTS OF THE PRESENT DISCLOSURE

A general object of the present disclosure is to overcome the problems associated with the existing waste management and recycling systems and provide a simple, compact, and efficient sandsplash system for removing contaminants from polymer components plastic waste, and Municipal Solid Waste (MSW).

Yet another object of the present disclosure is to remove contaminants from the polymer component using combination of blasting operation and tumbling operation.

Yet another object of the present disclosure is to remove moisture from the polymer component before actuation of blasting operation and tumbling operation.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The sandsplash system for cleaning polymer components from municipal solid waste using utilizing abrasive materials or blasting media like coarse or fine sand, natural minerals, or similar particles. The sandsplash system may use one or more operations like splashing, flipping, rotating, mixing, and firing these materials, utilizing pneumatic pressure or tumbling to facilitate abrasion. This process may involve rubbing the abrasive particles or blasting media against dirty or contaminated polymer components, effectively removing dirt particles from polymer components that are in the form of chips or flakes. The cleaned polymer components are chips or flakes extracted from the chamber which may be ready for further operations like recycling.

FIG. 1 illustrates an exemplary diagram of the proposed sandsplash system for removing contaminants from polymer components, in accordance with an embodiment of the present disclosure.

FIG. 2 illustrates an exemplary block diagram of the proposed sandsplash method for removing contaminants from polymer components, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Embodiments explained herein relate to the technical field of waste management and recycling systems. In particular, it relates to a simple, compact, and efficient system and method for removing contaminants from polymer components, plastic waste, and Municipal Solid Waste (MSW).

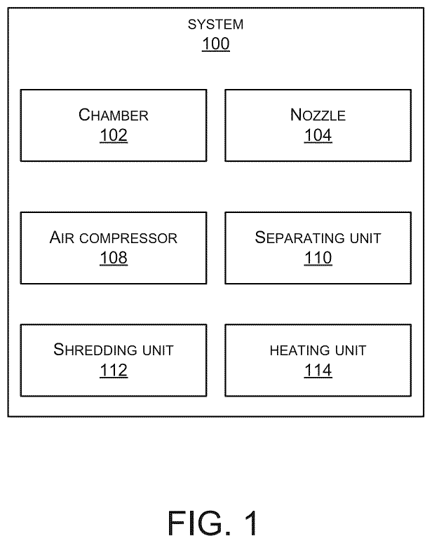

FIG. 1 illustrates an exemplary diagram of the proposed sandsplash system for removing contaminants from polymer components, in accordance with an embodiment of the present disclosure. According to an embodiment of the present disclosure and referring to FIG. 1, the proposed sandsplash system (collectively designated as 100, herein) for removing contaminants from polymer components, plastic waste, and Municipal Solid Waste (MSW) is disclosed. In an embodiment, the system 100 can include a chamber 102, a nozzle 104, a blasting media 106, an air compressor 108, a shredding unit 112, and a heating unit 114. In an exemplary embodiment, the polymer components can be plastic. The plastic waste in municipal solid waste may include a polyethylene terephthalate (PET), a high-density polyethylene (HDPE), a polyvinyl chloride (PVC), a low-density polyethylene (LDPE), a polypropylene (PP), and a polystyrene (PS). The above plastics may be packaging carry bag, bottle, bag, container, Multilayer Packaging, and single-use item.

In an embodiment, the chamber 102 can be configured to correspondingly allow a tumbling operation on the polymer components. The predefined quantity of blasting media 106 can be tumbled along with the moisture-free polymer components to remove contaminants from the surface of the polymer components. The chamber 102 can be configured to enable at least one of a vibration mode or a rotation mode. The at least one of a vibration mode or a rotation mode can enable the tumbling operation on the polymer components after removing moisture from the polymer components. In an exemplary embodiment, a motor can be configured to the chamber 102 to enable any one or a combination of the vibration mode or the rotation mode. In another exemplary embodiment, the chamber 102 can be selected from but not limited to a group comprising a rotary tumblers, a vibratory tumblers, a barrel tumblers, deburring tumblers, ultrasonic cleaners, parts washers, magnetic tumblers.

In an embodiment, the nozzle 104 can be configured within the chamber 102 to allow a mixture to be splashed on the polymer components. The mixture can be a predefined portion of air jet and a blasting media 106. In an exemplary embodiment, the nozzle 104 can be selected from but not limited to a group comprising a flat fan nozzle, a full cone nozzle, a hollow cone nozzle, an air atomizing nozzle, a rotary nozzle, an adjustable cone nozzle, a high-pressure nozzle, and a misting nozzle.

In an embodiment, the blasting media 106 can be a predetermined sand. The predetermined sand can be any or a combination of a silica sand, an aluminum oxide, a garnet or a plastic grit.

In an embodiment, the air compressor 108 can be operatively coupled to the nozzle 104. The coupling can be selected from but not limited to a group comprising a flange connection, a compression fitting, a barbed fitting, a hose connection, a quick-connect coupling, and a threaded connection. The air compressor can be configured to generate the air jet. In an exemplary embodiment, an air compressor 108 can be selected from but not limited to a group comprising a reciprocating air compressor, a rotary screw air compressor, a centrifugal air compressor, an oil-free scroll air compressor, an oil-free reciprocating air compressor, a high-pressure air compressor, a portable diesel air compressor, a variable speed drive (VSD) air compressor.

In an embodiment, the separating unit 110 can be operatively coupled to the chamber 102 using a first conveyor belt system. The separating unit 110 can be configured to separate a raw polymer component received from a municipal solid waste and correspondingly transfer them through the first conveyor belt system to the shredding unit 112 for further processing. In an exemplary embodiment, the separating unit 110 can be selected from but not limited to a group comprising a trommel screen, a vibrating screen, an air classifier, an eddy current separator, a density separator, a ballistic separator, a waste sorting robot, and an optical sorting machine.

In an embodiment, the shredding unit 112 can be operatively coupled to the chamber 102 using a second conveyor belt system. The shredding unit 112 can be configured to shred the polymer components received from the separating unit 110 and correspondingly transfer the shredded polymer components to the chamber 102 using the second conveyor belt system. The shredding unit 112 can be selected from but not limited to a group comprising a single shaft shredder, a dual shaft shredder, a granulator, a plastic bottle shredder, a plastic lump shredder, a high-capacity shredder, a plastic film shredder, and a mobile shredding system.

In an embodiment, the heating unit 114 can be operatively coupled to the nozzle 104. The coupling can be selected from but not limited to a group comprising a flange connection, a compression fitting, a barbed fitting, a hose connection, a quick-connect coupling, and a threaded connection. The heating unit 114 can be configured to receive an air jet at a predefined pressure from the air compressor 108. The heating unit 114 can be configured to heat the received air jet. In addition, the heating unit 114 can transfer the heated air jet to the chamber 102, containing the shredded polymer components with moisture. Further, the heating unit 114 can circulate the heated air jet within the chamber 102 to remove moisture from the shredded polymer components during which the tumbling operation will not be performed. The chamber 102 can be rotating or vibrating during the circulation of hot air within the chamber 102 in a manner that the polymer components may effectively receive hot air over a surface of the polymer components for quick removal of moisture from the surface. The heating unit 114 can be selected from but not limited to a group consisting of a forced air furnace, an electric baseboard heater, a heat pump system, a unit heater, an infrared heater, a space heater, a ductless mini-split system, and a radiant tube heater.

In an exemplary embodiment, the sandsplash system can be used for the effective removal of paint, plating, coatings, adhesives, and decorative or protective layers from the polymer components.

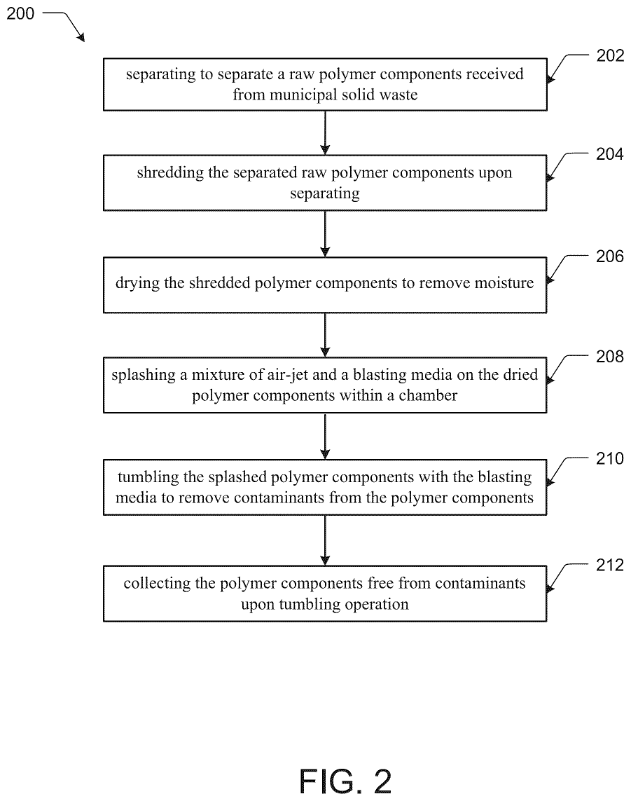

FIG. 2 illustrates an exemplary block diagram of the proposed sandsplash method for removing contaminants from polymer components, in accordance with an embodiment of the present disclosure. According to another embodiment, the present disclosure pertains to a sandsplash method for removing contaminants from polymer components, plastic waste, and Municipal Solid Waste (MSW).

At block 202, the method 200 may include the steps of separating a raw polymer components received from municipal solid waste using a separating unit.

At block 204, the method 200 may include the steps of shredding the separated raw polymer components using a shredding unit.

At block 206, the method 200 may include the steps of drying the shredded polymer components to remove moisture using a heating unit.

At block 208, the method 200 may further include the steps of splashing a mixture of air-jet and a blasting media in a predefined portion to be splashed on the dried polymer components within a chamber 102 using a nozzle.

At block 210, further the method may comprise the steps of tumbling the splashed polymer components with the blasting media to remove contaminants from the polymer components using the chamber 102.

At block 212, the method may include the steps of collecting the polymer components free from contaminants using a container.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present invention overcomes the problems associated with the existing waste management and recycling systems. The present invention provides for a simple, compact, and efficient sandsplash system for removing contaminants from polymer components, plastic waste, and Municipal Solid Waste (MSW).

The present invention removes contaminants from the polymer component using combination of blasting operation and tumbling operation.

The present invention removes moisture from the polymer component before actuation of blasting operation and tumbling operation.

We claim:

1. A sandsplash system for removing contaminants from polymer components, plastic waste, and Municipal Solid Waste (MSW), the system (100) comprising:
a chamber (102); and
a nozzle (104) configured to allow a mixture of air jet and a blasting media (106) in a predefined portion to be splashed on the polymer components within the chamber (102);
wherein the chamber (102) is configured to correspondingly allow a tumbling operation on the polymer components using the blasting media (106) within the chamber (102) to remove contaminants from the polymer components.

2. The system (100) as claimed in claim 1, wherein the system (100) comprises an air compressor (108) operatively coupled to the nozzle (104), and is configured to generate the air jet.

3. The system (100) as claimed in claim 1, wherein the system (100) comprises a separating unit (110) operatively coupled to the chamber (102), the separating unit (110) is configured to separate a raw polymer components received from a municipal solid waste.

4. The system (100) as claimed in claim 1, wherein the system (100) comprises a shredding unit (112) operatively coupled to the chamber (102), the shredding unit (112) is configured to shred the polymer components received from the separating unit (110) and correspondingly transfer the shredded polymer components to the chamber (102). The system (100) as claimed in claim 1, wherein the system (100) comprises a heating unit (114) operatively coupled to the nozzle (104), and the heating unit (114) is configured to:
receive air jet from the air compressor (108);
heat the received air jet;
transfer the heated air jet to the chamber (102) containing the shredded polymer components with moisture; and
circulating the heated air jet within the chamber (102) to remove moisture from the shredded polymer components.

6. The system (100) as claimed in claim 1, wherein the chamber (102) is configured to enable at least one of a vibration mode or a rotation mode to enable the tumbling operation on the polymer components upon removing moisture from the polymer components.

7. The system (100) as claimed in claim 1, wherein the polymer components are any or combination of a polyethylene terephthalate (PET), a high-density polyethylene (HDPE), a polyvinyl chloride (PVC), a low-density polyethylene (LDPE), and a polypropylene (PP), and a polystyrene (PS).

8. The system (100) as claimed in claim 1, wherein the blasting media (106) is a predetermined sand.

9. A sandsplash method for removing contaminants from polymer components, plastic waste, and Municipal Solid Waste (MSW), the method (200) comprises the steps of:
separating (202), using a separating unit (110), a raw polymer components received from municipal solid waste;
shredding (204), using a shredding unit (112), the separated raw polymer components upon separating;
drying (206), using a heating unit (114), the shredded polymer components to remove moisture upon shedding;
splashing (208), using a nozzle (104), a mixture of air-jet and a blasting media in a predefined portion to be splashed on the dried polymer components within a chamber (102) upon drying;
tumbling (210), using the chamber (102), the splashed polymer components with the blasting media (106) to remove contaminants from the polymer components; and
collecting (212), using a container, the polymer components free from contaminants upon tumbling operation.
